(19) United States
(12) Patent Application Publication
(10) Pub. No.: US 2017/0029755 A1
(43) Pub. Date: Feb. 2, 2017

(54) WINEMAKING TANK MADE OF A MAGMATIC MATERIAL

(71) Applicant: Wayne Mostert, Boulazac (FR)

(72) Inventor: Wayne Mostert, Boulazac (FR)

(21) Appl. No.: 15/303,938

(22) PCT Filed: Apr. 2, 2015
(86) PCT No.: PCT/FR2015/050865

§ 371 Date: Oct. 13, 2016

(30) Foreign Application Priority Data
Apr. 15, 2014 (FR) 1453369

(51) Int. Cl. C12H 1/22

(52) U.S. Cl. CPC C12H 1/22

(57) ABSTRACT

A winemaking tank (1) comprising a monolithic hollow body (2) for storing wine, having a smooth inner wall (4A) with a non-constant circular or oval section, defining a storage space (5) for the wine, wherein the hollow body (2) is made of magmatic material.

### BACKGROUND OF THE INVENTION

The invention relates to the field of winemaking and maturing of wines. It relates more specifically to a winemaking tank.

According to the countries, climate and “philosophy” of agricultural operations (traditional product, yield, etc.), the tanks used may be executed in different base materials.

The tanks traditionally used are vats made of oak wood. Vats of this kind allow moderate oxygenation of the wine. They also impart a woody taste to the wine and are involved in polymerisation of the tannins in order to achieve generally more rounded wines. Vats of this kind however afford limited capacity and remain all in all costly owing to the base material used. Furthermore, they remain difficult to disinfect, with the existing disinfection products generally displaying limited efficacy.

Tanks executed in stainless steel, coated steel, concrete and plastic are used as an alternative to vats made of oak. Although these materials offer certain advantages, they nevertheless display a number of disadvantages.

Stainless steel tanks have the advantage of being neutral and devoid of direct influence on the wine stored therein. Furthermore, they are easy to maintain and therefore the risk of bacterial proliferation is practically zero. They have the drawback however of displaying high thermal conductivity, so that it is necessary to resort to additional methods for controlling the temperatures for the purpose of fermentation of the wine (streaming, encirclement, etc.). The wine stored in such tanks is furthermore subjected to highly reducing conditions, the consequence of which is frequently production of highly unpleasant sulphurous odours, often resembling a smell of “rotten eggs”. Moreover, stainless steel remains an expensive material.

Coated steel tanks offer the advantage of preserving the aroma of the wine. Cleaning of such tanks proves difficult however. Indeed, during storage of the wine in the tank, vinous deposits settle on the inner walls of the latter, forming a deposit that should be regularly removed in order to avoid any bacterial proliferation. These deposits are generally removed by scraping. It frequently happens that the scraping operation damages the coating, which may not only potentially lead to proliferation of bacteria, but may also affect the quality of the barrier function of the coating. The wine stored in a tank having a damaged coating may therefore lose its quality. Furthermore, it generally acquires a bad taste. Coated steel tanks therefore require regular inspections, both from the point of view of their leaktightness and their hygiene. Additionally, as is the case with stainless steel tanks, such tanks display high thermal conductivity.

Concrete tanks offer the advantage of providing good thermal inertia. They make it possible to maintain stable temperatures in the wine without requiring major energy expenditure. In order to allow storage of wine however, concrete tanks must be equipped with an internal coating. They therefore have the same disadvantages as those encountered with coated steel tanks related to the internal coating and its cleaning and disinfection (risk of spoilage). Concrete tanks therefore require regular inspections, both from the point of view of their leaktightness and their hygiene.

Plastic tanks (particularly made of polyester) have the advantage of being inexpensive and of offering variable shapes and volumes. The innocuousness of this type of tank towards the wine remains average however. Furthermore, they deteriorate over time, which may result in a loss of quality of the stored wine. Moreover, when the wine is stored for an excessively long period in plastic tanks, it also finally deteriorates. In addition, plastic tanks likewise have high thermal conductivity.

The invention aims to solve these problems by providing a winemaking tank having low thermal inertia and ensures limited bacterial proliferation while preserving the natural aromas of the wine contained in the tank.

The invention also aims to provide a winemaking tank that is resistant over time and does not require any prior treatment for storage of wines.

### SUMMARY OF THE INVENTION

For this purpose, according to a first aspect, the invention provides a tank for vinifying wine comprising a monolithic hollow body for storing wine, having a smooth inner wall with a non-constant circular or oval section, defining a storage space for the wine, wherein the hollow body is made of magmatic material.

“Non-constant circular or oval section” means a body having a circular or oval section that varies along its longitudinal axis.

“Smooth wall” means a non-porous wall. The smooth nature of the inner wall of the hollow body can be obtained by polishing the wall.

The combination of the material (magmatic material which has low thermal inertia), of the quality of the inner wall of the tank with which the wine is in contact (smooth wall) and the shape of the latter (shape, circular or oval and non-constant) enhances the agitation phenomenon naturally obtained and thus mixing of the wine, moreover uniformly.

Added to this are the advantages intrinsic to the magmatic material itself. In particular, one of the advantages of a magmatic material is to allow a polish, advantageously a brilliant polish, in order to improve its impermeable nature in addition to its hardness. Furthermore, being non-porous, it does not require use of a protective layer and remains relatively stable. Consequently, there is little risk of the tank's being subject to bacterial proliferation. It furthermore offers a much longer service life than the materials used to date for producing winemaking tanks, which general display some degree of porosity. Besides, being inert, it enables preservation of the natural aromas of the wine contained in the tank.

Advantageously, the tank material is basalt or granite.

Advantageously, the inner wall is arranged in order to define a receiving space with a, preferably inverted, ovoid shape. The advantage of this shape is that it encourages the natural convection movement. This thus enhances the efficiency of the operation of rousing the lees when the latter is performed.

Advantageously, the hollow body has an oval-shaped outer wall, preferably with an ovoid shape.

Advantageously, the tank comprises a base supporting the hollow body. According to an advantageous embodiment, the base is formed in one piece with the hollow body.

### BRIEF DESCRIPTION OF THE DRAWINGS

Further objectives and advantages of the invention will become apparent from the following description made in reference to the appended drawings, wherein:

FIG. 1 shows a schematic view of the winemaking tank according to the invention;

FIG. 2 shows a cross-sectional view of the winemaking tank along the axis II-II;

FIG. 3 shows a cross-sectional view of the winemaking tank in FIG. 2 along the axis III-III;

FIG. 4 shows a cross-sectional view of the winemaking tank in FIG. 2 along the axis IV-IV.

### DETAILED DESCRIPTION

In relation to FIGS. 1 to 4, a tank 1 is described, intended for vinification of wine, comprising a monolithic hollow body 2 and a base 3 supporting the hollow body 2. In the embodiment illustrated, the hollow body 2 is formed in one piece with the base 3. It is evidently understood that the base 3 may be a component separate from the hollow body 2 without going beyond the ambit of the invention.

The tank 1 intended for vinification of wine will be referred to hereinafter interchangeably as “winemaking tank 1” and “tank 1”.

The hollow body 2 of the tank 1 has an inner wall 4A defining a storage space 5 for the wine. In order to aid the movement of the wine that occurs in the tank 1, a movement which will be described below, the inner wall 4A is smooth.

The inner wall 4A of the hollow body 2 is configured in order to define a receiving space 5 with an inverted ovoid shape. This inverted ovoid shape, or oval shape with a single axis of symmetry, makes it possible to encourage natural agitation of the wine contained in the tank 1, as will be described in detail below.

Advantageously, the outer wall 4B is likewise ovoid in shape. Unlike the inner wall 4A, it is not inverted such that the side wall 4 of the hollow body 2 increases in thickness in the direction of the base 3 of the tank 1. It is evidently understood that the tank is not limited to such a shape and that it may have an outer wall 4B of any shape. According to one particular configuration, the hollow body 2 will be arranged in order to display a geometry consistent with the golden ratio.

The hollow body is made of magmatic material, such as for example basalt or granite. The advantage of use of this type of material lies in reducing thermal exchanges in addition to bacterial proliferation. Furthermore, it reduces the interactions between the hollow body 2 itself and the wine contained in the latter. The natural aromas of the wine are thus preserved.

Advantageously, the upper section of the hollow body 2 (end opposite the base 3) has a collar 6 defining an opening through which the wine to be vinified is introduced into the storage space 5. The opening is closed by a movable cover 7 mounted on the collar 6. Arrangement of the opening on the upper section of the hollow body 2 allows filling of the tank with a swirling flow of the wine, thereby ensuring homogenization of the latter.

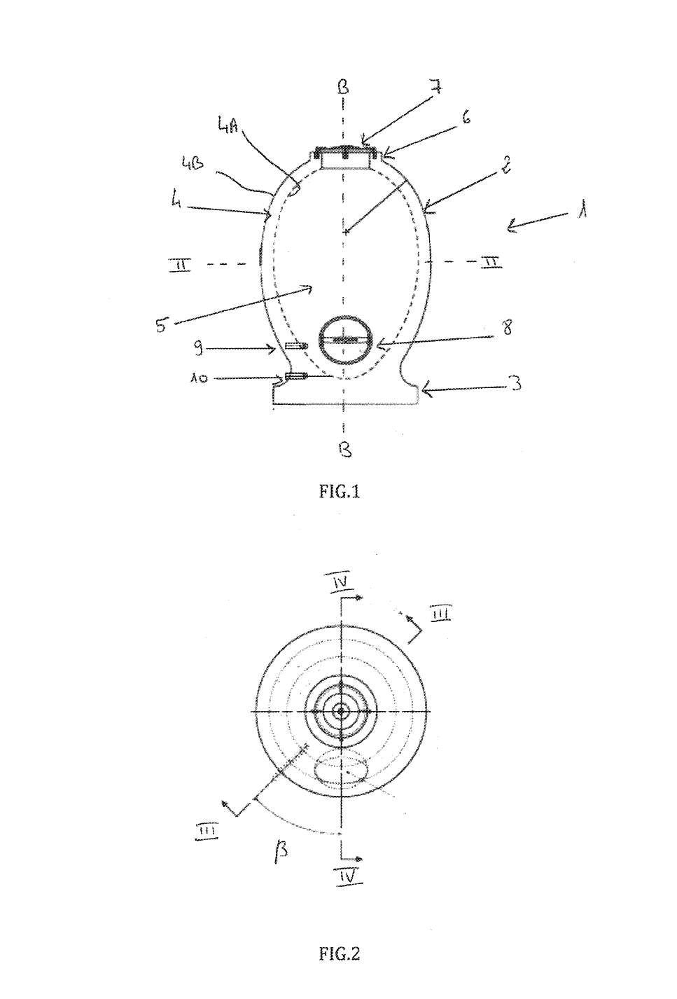

The tank 1 furthermore comprises means 9, 10, 11 allowing extraction of the wine from the storage space 5. More specifically, the tank 1 comprises first and second means designed respectively for emptying and racking. As illustrated in FIG. 2, said means 9, 10 are contained in a plane passing through the longitudinal axis BB of the hollow body 2 and extend in the same direction. As illustrated in this same figure, said means 9, 10 are angularly spaced by an angle β of approximately 45 degrees. One of the means 9, 10 is arranged so as to extend from the bottom 50 of the storage space 5. The tank 1 furthermore comprises a third means 11 of drawing wine for the purpose of its tasting. In the embodiment illustrated, the third means 11 is positioned in the same plane as that containing the first and second means 9, 10 (FIG. 3). The third means 11 is located at a height greater than the height corresponding to half the storage space 5 of the tank 1.

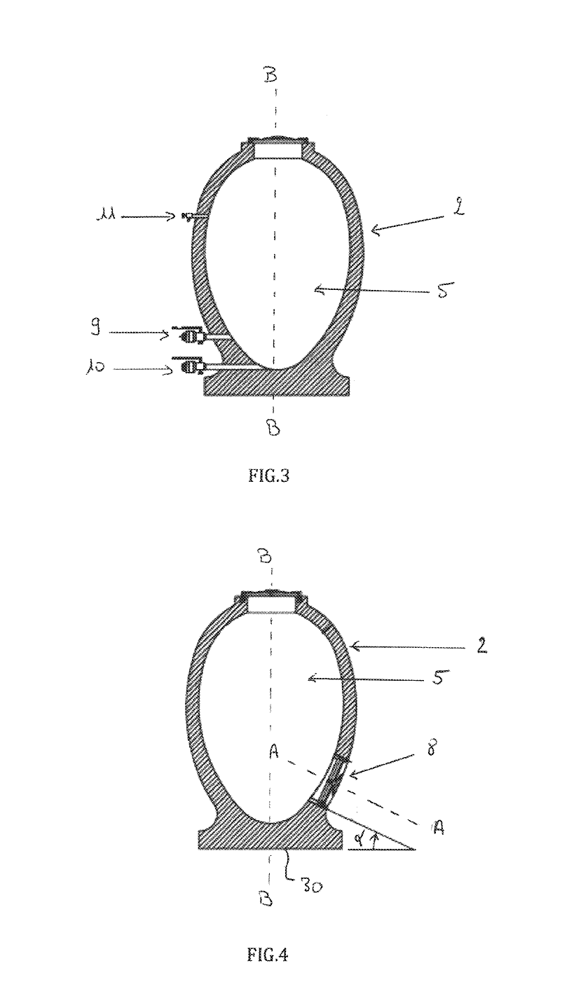

The winemaking tank 1 furthermore comprises a door 8 allowing cleaning of the tank 1. The door 8 is positioned in the bottom section, near the base 3 of the tank 1. More specifically, and as illustrated in FIG. 4, the door 8 is positioned so as to define an axis of entry AA having an angular spacing a in relation to a plane corresponding to the bottom face 30 of the base 3 of between 10 and 20 degrees. In the embodiment illustrated, the angular spacing a is approximately 25 degrees. “Bottom face” means the face of the base 3 resting on the ground. “Axis of entry” means the axis substantially perpendicular to the side wall 4 of the hollow body 2.

Owing to the shape of the winemaking tank 1 and of the material of which it is made, the wine, when introduced into the storage space 5, undergoes gentle agitation due to natural convection. This agitation arises from the temperature difference existing between the wall 4 of the tank 1 and the wine. The change in temperature of the wall of the tank 1 will influence the layer of wine in the vicinity of the inner wall 4A and thus change the temperature of the latter, subsequently modifying the density of this wine in the vicinity of the inner wall 4A. This difference in density will result in ascent or descent of the wine in the vicinity of the inner wall 4A of the tank 1. Hence, when the temperature of the inner wall 4A of the winemaking tank 1 is less than the temperature of the wine, the latter, in the vicinity of the inner wall 4A, will cool. This cooling results in an increase in the density of the wine. Owing to the ovoid shape of the inner wall 4A, the layer of wine close to the inner wall 4A converges towards the bottom in the direction of the centre, forcing an eddy of central current upwards in a substantially vertical direction. Conversely, when the temperature of the inner wall 4A of the winemaking tank 1 is greater than the temperature of the wine, the latter, in the vicinity of the inner wall 4A, will increase in temperature by heat transfer. This heating results in a reduction in density. The layer of wine close to the inner wall 4A converges upwards in the direction of the centre, forcing an eddy of central current downwards in a substantially vertical direction. This process will continue, solely maintained by the ambient temperature in the cellar that fluctuates from day to day and with the changing seasons. The agitation thus obtained may be compared to gentle rousing.

The ovoid shape of the inner wall thus prevents the wine from being in a stagnant state in the entire storage space 5 of the winemaking tank 1, thereby helping to prevent growth of pathogenic bacteria. The shape avoids formation of dead zones in which the wine would not be in contact with the lees.

In the embodiment described above, the winemaking tank 1 comprises a door 8. It is evidently understood that the tank according to the invention may be designed without a door.

The invention is described above as an example. It is understood that those skilled in the trade are capable of creating different alternative embodiments of the invention without departing from the framework of the invention.

1. A winemaking tank comprising:
a monolithic hollow body for storing wine, having a smooth inner wall with a non-constant circular or oval section, defining a storage space for the wine, wherein the hollow body is made of magmatic material.

2. The winemaking tank according to claim 1, wherein the material is basalt.

3. The winemaking tank according to claim 1, wherein the material is granite.

4. The winemaking tank according to claim 1, wherein the inner wall is arranged in order to define a receiving space with an inverted ovoid shape.

5. The winemaking tank according to claim 1, wherein the hollow body has an ovoid-shaped outer wall.

6. The winemaking tank according to claim 1, wherein the tank comprises a base supporting the hollow body.

7. The winemaking tank according to claim 6, wherein the base is formed in one piece with the hollow body.
